(19) United States
(12) Patent Application Publication
(10) Pub. No.: US 2008/0229027 A1
(43) Pub. Date: Sep. 18, 2008

(54) PREFETCH CONTROL DEVICE, STORAGE DEVICE SYSTEM, AND PREFETCH CONTROL METHOD

(75) Inventors: Katsuhiko SHIOYA, Kawasaki (JP); Eiichi Yamanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/046,090

(22) Filed: Mar. 11, 2008

(30) Foreign Application Priority Data
Mar. 13, 2007 (JP) 2007-64025

(51) Int. Cl. G06F 12/08

(52) U.S. Cl. 711/137; 711/E12.057

(57) ABSTRACT

A prefetch control device controls prefetching of read-out data into cache memory which improves efficiency of data reading from a storage device by caching data passed between the storage device and a computing device, determines whether data read out from the storage device to the computing device is sequentially accessed data or not, decides a prefetch amount for the read-out data in accordance with a predetermined condition if the read-out data is determined to be sequentially accessed data, and prefetches the read-out data of the prefetch amount.

### BACKGROUND

1. Field

This device, system and method relate to a prefetch control device, a storage device system, and a prefetch control method for controlling prefetch of data read into cache memory which improves efficiency of data reading from a storage device by caching data passed between the storage device and a computing device. More particularly, this device, system and method relate to a prefetch control device, a storage device system, and a prefetch control method that avoid exhaustion of cache memory resulting from prefetching.

2. Description of the Related Art

As the processing ability of computers has increased, more and more data has been utilized on computers. Techniques for efficiently reading/writing an enormous amount of data between a computer and a storage device have been investigated.

For instance, a storage system called Redundant Arrays of Inexpensive Disks (RAID) is known that centrally manages a number of storage devices with a control device. A RAID storage system can realize high-speed data reading/writing, a data storage area of a large capacity, and high reliability of data reading/writing and storage.

The control device of such a storage system typically has a cache memory. The cache memory can be accessed at a higher speed than a storage device. The cache memory stores data written by a computer temporarily, as well as storing data read out to the computer, so data can be read and written efficiently.

Frequently-used data is placed in the cache memory. The cache memory is accessed, instead of the storage device, if data written by the computer to the storage device or data read out from the storage device to the computer is present in the cache memory. Such an arrangement enables efficient and prompt data reading/writing from/to the storage device.

Control for efficiently and speedily reading out data to the computer is a critical issue for such a cache memory. In particular, when handling data that can be of a large amount and should be sequentially accessed, such as audio data and moving picture data, reading performance of the storage device can be enhanced through control for reading out (or prefetching) the sequentially accessed data in advance from the storage device and temporarily storing the data in cache memory.

With conventional techniques, however, because control for increasing the amount of prefetching is performed and prefetching continues to take place as long as a certain condition is satisfied, cache memory can run short due to prefetching of an increased amount of data.

### SUMMARY

This device, system and method have been made for solving the problem or challenge outlined above, and has an object of providing a prefetch control device, a storage device system, and a prefetch control method for avoiding exhaustion of cache memory which caches data passed between a storage device and a computing device due to prefetching of data read out from the storage device.

The above-described embodiments are intended as examples, and all embodiments are not limited to including the features described above.

### BRIEF DESCRIPTION OF THE DRAWINGS

FIG. 1 illustrates the overview and features of an embodiment;

FIG. 2 is a functional block diagram showing a configuration of a RAID control device according to the embodiment;

FIG. 3 shows an example of a cache memory status table;

FIG. 4 shows an exemplary table of a per-LUN cache hit ratio;

FIG. 5 illustrates detection of sequentiality and prefetching operations;

FIG. 6 illustrates prefetching operations; and

FIG. 7 is a flowchart illustrating the procedure of a prefetch amount controlling process.

### DETAILED DESCRIPTION OF THE PREFERRED EMBODIMENTS

Reference may now be made in detail to embodiments, examples of which are illustrated in the accompanying drawings, wherein like reference numerals refer to like elements throughout.

An embodiment of the prefetch control device, storage device system and prefetch control method will be described in detail with reference to the attached drawings. The embodiment shown below illustrates a case where the system is applied to a disk system called RAID (Redundant Arrays of Inexpensive Disks). A RAID disk system realizes high-speed data reading/writing, large capacity, and high reliability by combination of multiple magnetic disk devices.

In this case, the prefetch control device is a control circuit (e.g., an LSI (Large Scale Integration)) of a RAID control device (a RAID controller). The RAID controller centrally controls the magnetic disk devices and connects the magnetic disk devices with a computing device.

Although the embodiment shown below illustrates an application of the device, system and method to magnetic disks as storage media and a magnetic disk device as a storage device, the device, system and method are not limited thereto and are also applicable to other types of storage medium and disk device, e.g., optical disks and an optical disk device, or magneto-optical disks and a magneto-optical disk device.

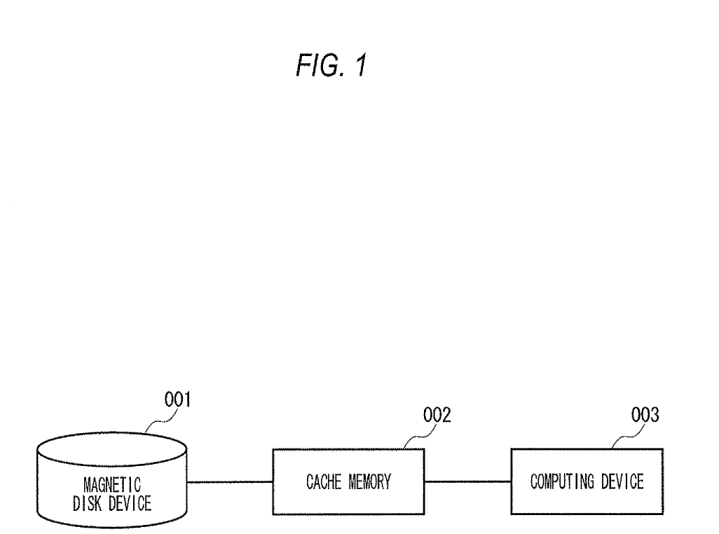

The overview and features of the embodiment will be described first. FIG. 1 illustrates the overview and features of an embodiment. As shown in FIG. 1, this embodiment assumes a magnetic disk system in which a computing device 003 and a magnetic disk device 001 are connected to each other via cache memory 002. In this situation, a read request is issued by the computing device 003 to the magnetic disk device 001.

Prefetching of a fixed size and a fixed amount is performed if the data which is read out in response to the read request is determined to have sequentiality. Here, sequentiality means a file access in which data being read/written has continuity and written/read-out data with sequentiality is referred to as sequentially accessed data. Additionally, prefetching refers to advance reading of data from the magnetic disk device 001 to the cache memory 002. Advance reading of data is effective when data being read out is sequentially accessed data.

Here, one conventional problem is that prefetching of a fixed size and a fixed amount irrespective of the remaining capacity of the cache memory 002 will exhaust the cache memory 002 due to prefetching and degrade the performance of the entire system.

To address this, this embodiment changes the size and amount of prefetching dynamically in accordance with the remaining capacity of the cache memory 002, so as to prevent exhaustion of the cache memory 002 and avoid performance degradation of the entire system.

Dynamic change of the size and amount of prefetching in accordance with the remaining capacity of the cache memory 002 refers to decreasing the size or amount of prefetching when the remaining capacity of the cache memory 002 has fallen below a threshold value, or increasing the same when the remaining capacity of the cache memory 002 is above the threshold value, for example. The dynamic change also includes control for stopping prefetching and resuming it when the remaining capacity of the cache memory 002 has recovered to a certain amount, especially when the remaining capacity of the cache memory 002 has become extremely small.

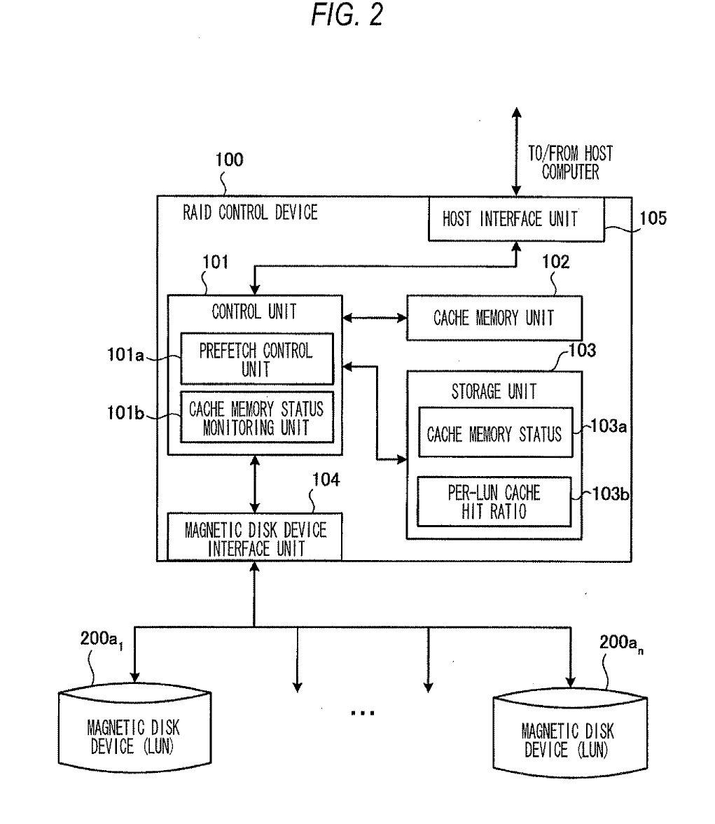

The configuration of the RAID control device according to another embodiment is described next. FIG. 2 is a functional block diagram showing the configuration of the RAID control device according to this embodiment. As shown in the figure, a RAID control device 100 is connected to magnetic disk devices 200a1, . . . , 200an and to a host computer (not shown), relaying written/read-out data between the magnetic disk devices 200a1, . . . , 200an and the host computer. A magnetic disk device 200ai (i=1, . . . , n) is called LUN (logical unit number). Although herein the LUN is assigned based on physical magnetic disk devices, it may also be based on logical magnetic disk devices.

The RAID control device 100 includes a control unit 101, a cache memory unit 102, a storage unit 103, a magnetic disk device interface unit 104 which serves as an interface for data passing to/from the RAID control device 100, and a host interface unit 105 which serves as an interface for data passing to/from the host computer not shown.

The control unit 101 is responsible for control of the entire RAID control device 100, caching data read from the magnetic disk devices 200a1, . . . , 200an in the cache memory unit 102, and also caching data written by the host computer to the magnetic disk devices 200a1, . . . , 200an in the cache memory unit 102.

The control unit 101 further includes a prefetch control unit 101a and a cache memory status monitoring unit 101b as components pertaining to this embodiment. The prefetch control unit 101a determines whether data read from the magnetic disk devices 200a1, . . . , 200an has sequentiality. If the prefetch control unit 101a determines the data is sequential, it prefetches and caches the data in the cache memory unit 102.

Furthermore, when the read-out data has sequentiality, the prefetch control unit 101a controls the amount of prefetching in accordance with various conditions stored in the storage unit 103 (e.g., remaining cache memory capacity, cache hit ratio, cache hit ratio per LUN, etc.). Although in this embodiment the amount of prefetching to be controlled refers to the number of data to prefetch, this is not a limitation and it may be the length of data that is prefetched in each prefetching.

The cache memory status monitoring unit 101b monitors the remaining capacity and cache memory hit ratio of the cache memory unit 102. The cache memory status monitoring unit 101b also monitors the hit ratio of cache memory for each LUN all the time. The cache memory status monitoring unit 101b stores the results of such monitoring in predetermined areas of the storage unit 103.

The cache memory unit 102 is Random Access Memory (RAM) capable of high-speed reading/writing for temporarily storing (or caching) data written by the host computer not shown to the magnetic disk devices 200a1, . . . , 200an as well as data read out from the magnetic disk devices 200a1, . . . , 200an. Data temporarily stored in the cache memory unit 102 purges or gets rid of old data according to the Least Recently Used (LRU) algorithm.

The storage unit 103 is volatile or non-volatile storage for storing cache memory status 103a and per-LUN cache hit ratio 103b. As the cache memory status 103a, the latest values and threshold values of the remaining capacity and cache hit ratio of the cache memory unit 102 are stored e.g., in a table format. As the per-LUN cache hit ratio 103b, cache hit ratio in the cache memory unit 102 for each LUN is stored, e.g., in a table format.

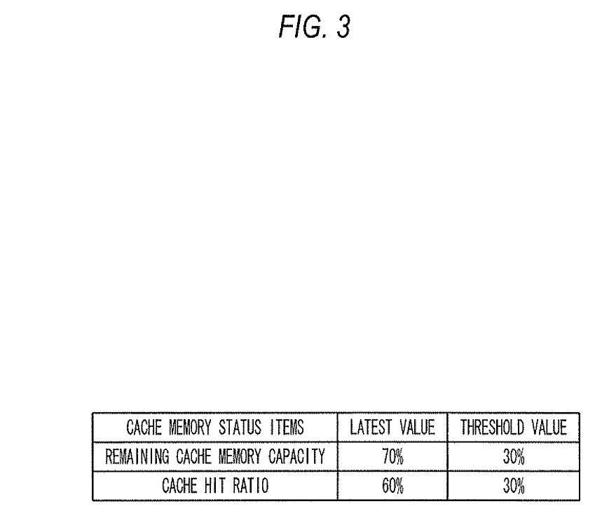

An exemplary table of the cache memory status 103a has columns of “cache memory status items”, “latest value”, and “threshold value” as shown in FIG. 3, for example. The “cache memory status items” include “remaining cache memory capacity” and “cache hit ratio”. The “remaining cache memory capacity” is expressed as the ratio of remaining available capacity of cache memory to the total capacity thereof. The “cache hit ratio” is expressed as the percentage of target input/output data being present in the cache memory unit 102 with respect to all input/output requests from the host computer not shown to the magnetic disk devices 200a1, . . . , 200an.

The “latest value” is the result of latest monitoring by the cache memory status monitoring unit 101b, and includes the “remaining cache memory capacity” and “cache hit ratio” which are constantly updated upon each monitoring. The “threshold value” is a reference value for determining whether the “remaining cache memory capacity” and “cache hit ratio” are large or small and/or high or low and can be arbitrarily set from outside.

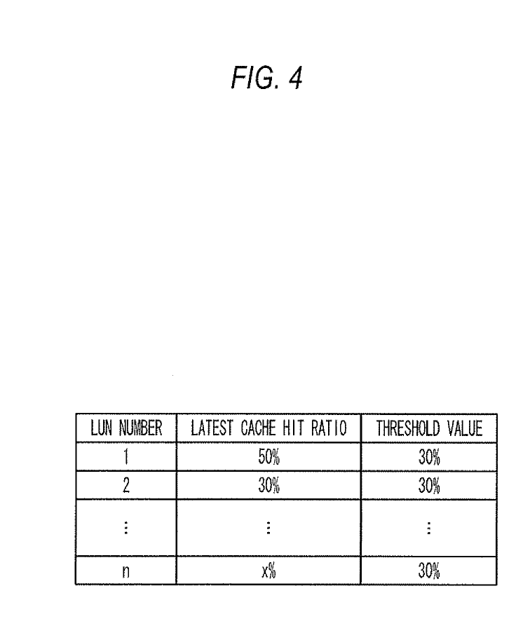

An exemplary table of the per-LUN cache hit ratio 103b has columns of “LUN number”, “latest cache hit ratio value”, and “threshold value” as shown in FIG. 4, for instance. The “LUN number” is the device number of the magnetic disk devices 200a1, . . . , 200an. The “latest cache hit ratio value” represents for each LUN the percentage of target input/output data being present in the cache memory unit 102 with respect to all input/output requests from the host computer not shown to the magnetic disk devices 200a1, . . . , 200an. This percentage is the result of the latest monitoring by the cache memory status monitoring unit 101b and constantly updated upon each monitoring. The “threshold value” is a reference value for determining whether the “latest cache hit ratio value” is large or small and can be arbitrarily set from outside.

The “remaining cache memory capacity”, the “latest value” and “threshold value” of “cache hit ratio”, and the “latest cache hit ratio value” and “threshold value” on a LUN basis which are represented by the ratios and percentages described above may also be represented as specific amounts (e.g., in bytes).

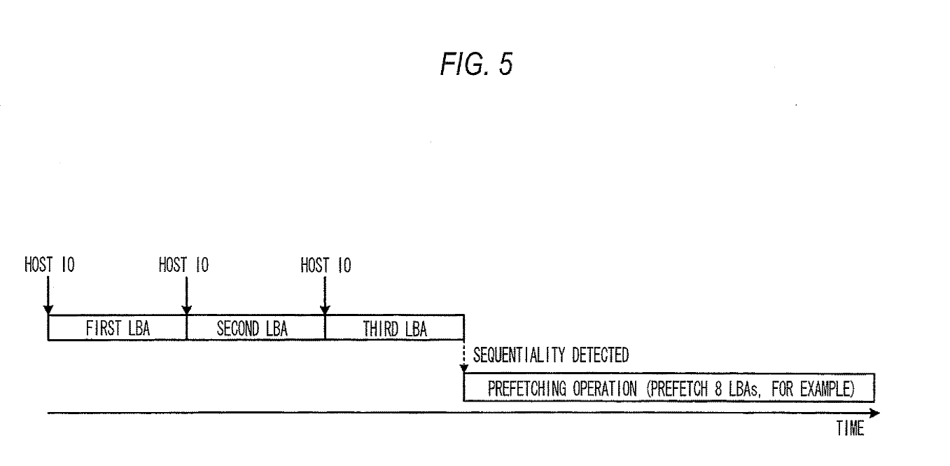

Detection of sequentiality and prefetching operations will be described next. FIG. 5 illustrates detection of sequentiality and prefetching operations. In FIG. 5, data reading from the magnetic disk devices 200a1, . . . , 200an is performed in units of Logical Block Addressing (LBA) consisting of 512-byte data and an 8-byte check code added, which is the size of one prefetching.

As shown in FIG. 5, in response to a first read request from the host computer (hereinafter called a host IO (host input/output)), a first LBA is read from the magnetic disk devices 200a1, . . . , 200an and cached in the cache memory unit 102. Subsequently, second and third LBAs are read from the magnetic disk devices 200a1, . . . , 200an successively in response to second and third host IOs and cached in the cache memory unit 102.

Here, if the first to third LBAs are sequential data, the first to third host IOs are determined to have sequentiality and eight LBAs will be subsequently prefetched in accordance with the detected sequentiality.

Thus, when a certain number of LBAs counted are sequential data, LBAs that will be read out for subsequent host IOs are also likely to be sequential data that follows. Therefore, a cache hit ratio can be improved by reading in advance (or prefetching) a predetermined number of sequential LBAs into the cache memory unit 102 in this way.

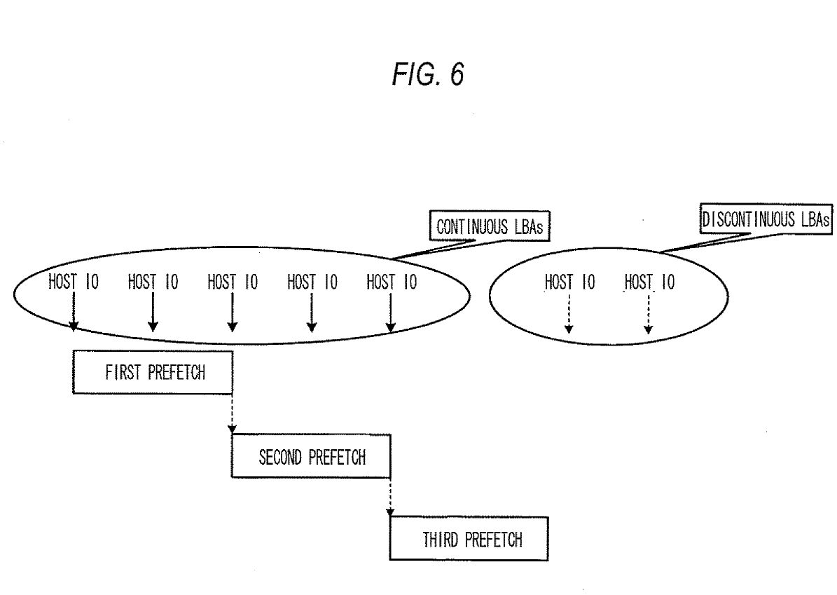

Prefetching operations will be now described. FIG. 6 illustrates prefetching operations. As shown in the figure, for host IOs relating to continuous LBAs, eight LBAs are prefetched when three host IOs relating to continuous LBAs are issued in succession as shown in FIG. 5, for example. In such a manner, eight LBAs are prefetched every time there is a successive issuance of three host IOs relating to continuous LBAs, but counting of sequential LBAs is initialized when there is a host IO relating to a discontinuous LBA. Cache hit ratio can be improved in this manner.

However, when a fixed number of LBAs counted are sequential data, if a predetermined number of sequential LBAs are prefetched and read into the cache memory unit 102 without regard to the finite capacity of the cache memory unit 102 as shown in FIGS. 5 and 6, available capacity of cache memory may become scarce when its cache hit ratio is low. On the other hand, by changing the size and amount of prefetching in accordance with the remaining capacity and cache hit ratio of cache memory by the method shown in this embodiment, it is possible to make scarcity of cache memory capacity due to prefetching less likely to occur.

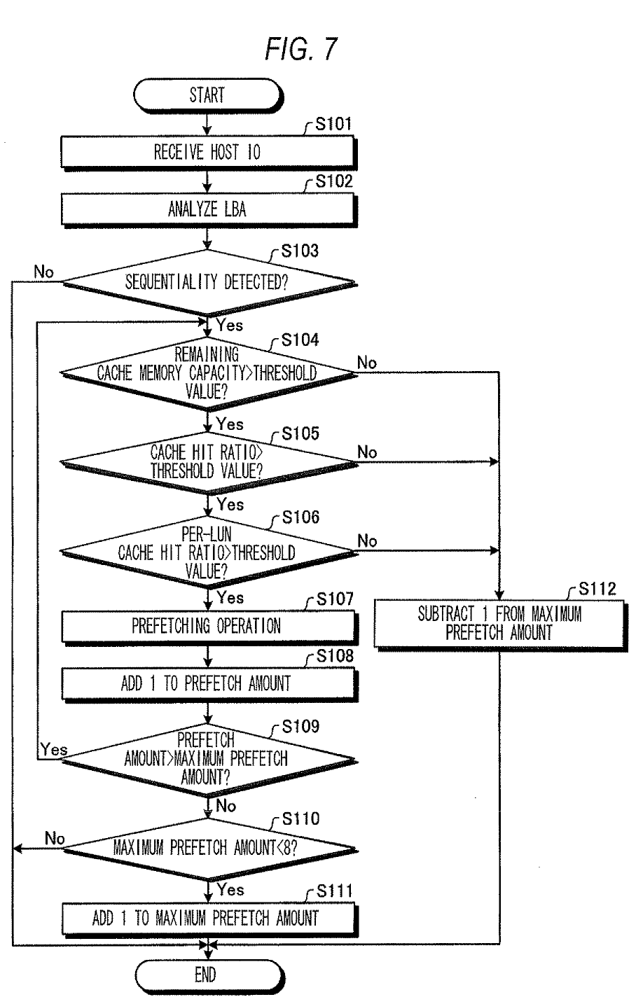

A process of controlling prefetch amount will be described next. FIG. 7 is a flowchart illustrating the procedure of a prefetch amount controlling process. It is assumed that “largest prefetch amount”, “threshold value for remaining cache memory capacity”, “threshold value for cache hit ratio”, and “threshold value for per-LUN cache hit ratio” to be discussed later are defined as preconditions for prefetch amount control in advance. As shown in the figure, the prefetch control unit 101a first receives a host IO from the host computer (operation S101). The prefetch control unit 101a then analyzes the sequentiality of an LBA which is read from the magnetic disk devices 200a1, . . . , 200an based on the host IO received at operation S101 (operation S102).

Then, the prefetch control unit 101a determines whether the LBA read from the magnetic disk devices 200a1, . . . , 200an that was analyzed at operation S102 has sequentiality or not (operation S103). Specifically, the prefetch control unit 101a compares the LBA with an LBA for the preceding host IO, and if they are continuous, it determines that the host IO is a sequential access. If it is determined that the LBA read from the magnetic disk devices 200a1, . . . , 200an has sequentiality (Yes at operation S103), the flow proceeds to operation S104, and if it is not determined so (No at operation S103), this prefetch amount control process is terminated.

At operation S104, the prefetch control unit 101a determines whether or not the remaining cache memory capacity of the cache memory status 103a has exceeded a threshold value. If it is determined that the remaining cache memory capacity has exceeded the threshold value (Yes at operation S104), the flow proceeds to operation S105, and if it is not determined so (No at operation S104), the flow proceeds to operation S112.

At operation S105, the prefetch control unit 101a determines whether or not the cache hit ratio of the cache memory status 103a has exceeded a threshold value. If it is determined that the cache hit ratio has exceeded the threshold value (Yes at operation S105), the flow proceeds to operation S106, and if it is not determined so (No at operation S105), the flow proceeds to operation S112.

At operation S106, the prefetch control unit 101a determines whether or not the cache hit ratio for each LUN of the per-LUN cache hit ratio 103b has exceeded its own threshold values. If it is determined that the cache hit ratio for each LUN has exceeded its threshold values (Yes at operation S106), the flow proceeds to operation S107, and if it is not determined so (No at operation S106), the flow proceeds to operation S112.

At operation S107, the prefetch control unit 101a prefetches one LBA. The prefetch control unit 101a then adds “1” to “prefetch amount”, which is a counter variable stored in a predetermined storage area (operation S108).

Then, the prefetch control unit 101a determines whether or not “prefetch amount”, the counter variable, is below the “largest prefetch amount” which is a counter variable stored in a predetermined storage area (operation S109). The “largest prefetch amount” indicates the limit for adding “1” to the “prefetch amount” at operation S108. If it is determined that the “prefetch amount” is below the “largest prefetch amount” (Yes at operation S109), the flow proceeds to S104, and if it is not determined so (No at operation S109), the flow proceeds to operation S110.

At operation S110, the prefetch control unit 101a determines whether or not the “largest prefetch amount” is less than 8, for example. The “largest prefetch amount” is not limited to the numerical value of “8” and may be appropriately set or changed as a numerical value that defines the performance of the storage device system. If it is determined that the “largest prefetch amount” is less than 8, for example (Yes at operation S110), the flow proceeds to operation S111, and if it is not determined so (No at operation S110), this prefetch amount control process is terminated. Then, at operation S111, the prefetch control unit 101a adds “1” to the “largest prefetch amount”. Meanwhile, at operation S112, the prefetch control unit 101a subtracts “1” from the “largest prefetch amount”.

While the embodiment of the device, system and method have been described above, they are not limited to this embodiment and may be practiced in various different embodiments within the scope of technical ideas set forth in Claims. In addition, the effect described in the embodiment is not limitative.

In the embodiment described above, the prefetch control device is implemented as a control circuit of a RAID controller. However, the prefetch control device is not limited thereto and may also be a RAID controller itself.

Although the above-described embodiment illustrates the storage system as a RAID system, RAID is not limitation and use of a single magnetic disk device is also contemplated. The magnetic disk device may be externally connected to or contained in a computing device. When the magnetic disk device is contained in a computing device, the prefetch control device is of course also contained in the computing device. Alternatively, the prefetch control device may be realized as a control device of a computing device and cache memory may be internal storage memory of the computing device.

Additionally, some or all of processes that are described above in the embodiment as automatically performed ones can also be performed manually, or some or all of processes that are described as manually performed ones can also be performed automatically by a known method. Furthermore, the procedures of processing and control, specific names, and information including various data and parameters shown in the above embodiment may be arbitrarily changed except as specified.

Also, the components of the devices shown in the figures represent functional concepts and do not necessarily require to be physically arranged as illustrated. That is, specific form of distribution or integration of the devices is not limited to the ones shown but some or all of them may be functionally or physically distributed or integrated in arbitrary units in accordance with various types of loads, utilization, and the like.

Furthermore, some arbitrary part or all of processing functions performed in the devices may be realized in a Central Processing Unit (CPU) (or a microcomputer such as a Micro Processing Unit (MPU) and a Micro Controller Unit (MCU)) and a program which is analyzed and executed by the CPU (or a microcomputer such as an MPU or MCU), or may be realized in hardware based on wired logics.

Although a few preferred embodiments have been shown and described, it would be appreciated by those skilled in the art that changes may be made in these embodiments without departing from the principles and spirit of the invention, the scope of which is defined in the claims and their equivalents.

What is claimed is:

1. A prefetch control device, comprising:
a prefetch control unit that controls prefetching of read-out data into cache memory which improves efficiency of data reading from a storage device by caching data passed between the storage device and a computing device;
a sequentiality determination unit that determines whether data read out from the storage device to the computing device is sequentially accessed data or not;
a prefetch amount decision unit that decides a prefetch amount for the read-out data in accordance with a predetermined condition if the read-out data is determined to be sequentially accessed data by the sequentiality determination unit; and
a prefetching unit that prefetches the read-out data of the prefetch amount decided by the prefetch amount decision unit.

2. The prefetch control device according to claim 1, wherein the prefetch amount decision unit decreases the prefetch amount when an available capacity of the cache memory has fallen below a predetermined threshold value, and increases the prefetch amount when the available capacity of the cache memory is not below the predetermined threshold value.

3. The prefetch control device according to claim 1, wherein the prefetch amount decision unit decreases the prefetch amount when a hit ratio of the cache memory has fallen below a predetermined threshold value, and increases the prefetch amount when the hit ratio of the cache memory is not below the predetermined threshold value.

4. The prefetch control device according to claim 1, wherein
the storage device includes a plurality of storage devices, and
the prefetch amount decision unit decreases the prefetch amount for each of the plurality of storage devices when the hit ratio of the cache memory for each of the plurality of storage devices has fallen below a predetermined threshold value, and increases the prefetch amount for each of the plurality of storage devices when the hit ratio of the cache memory for each of the plurality of storage devices is not below the predetermined threshold value.

5. The prefetch control device according to claim 1, wherein the prefetching unit stops prefetching when the prefetch amount decided by the prefetch amount decision unit has become zero, and resumes prefetching when the prefetch amount decided by the prefetch amount decision unit has become non-zero,

6. A storage device system that has a prefetch control device for controlling prefetching of read-out data into cache memory which improves efficiency of data reading from a storage device by caching data passed between the storage device and a computing device, comprising:
a sequentiality determination unit that determines whether data read out from the storage device to the computing device is sequentially accessed data or not;
a prefetch amount decision unit that decides a prefetch amount for the read-out data in accordance with a predetermined condition if the read-out data is determined to be sequentially accessed data by the sequentiality determination unit; and
a prefetching unit that prefetches the read-out data of the prefetch amount decided by the prefetch amount decision unit.

7. The storage device system according to claim 6, wherein the prefetch amount decision unit decreases the prefetch amount when an available capacity of the cache memory has fallen below a predetermined threshold value, and increases the prefetch amount when the available capacity of the cache memory is not below the predetermined threshold value.

8. A prefetch control method, comprising:
controlling prefetching of read-out data into cache memory which improves efficiency of data reading from a storage device by caching data passed between the storage device and a computing device;
determining whether data read out from the storage device to the computing device is sequentially accessed data or not;
deciding a prefetch amount for the read-out data in accordance with a predetermined condition if the read-out data is determined to be sequentially accessed data; and
prefetching the read-out data of the prefetch amount.
